(19) United States
(12) Patent Application Publication
(10) Pub. No.: US 2002/0093708 A1
(43) Pub. Date: Jul. 18, 2002

(54) Method and apparatus for the frequency band-dependent distribution and influencing of data signals of a WDM system

(76) Inventor: Dietmar Johlen, Muenchen (DE)

Correspondence Address: BELL, BOYD & LLOYD, LLC, P. O. BOX 1135, CHICAGO, IL, 60690-1135, US

(21) Appl. No.: 09/990,694

(22) Filed: Nov. 9, 2001

(30) Foreign Application Priority Data
Sep. 11, 2000 (DE) 100 55 477.6

(51) Int. Cl. H04J 14/02; H04B 10/00

(52) U.S. Cl. 359/124; 359/161

(57) ABSTRACT

A method and a device for the frequency-band dependent distribution and influencing of data signals of a WDM system, as a result of which a temporary rectification and subsequent correctly sequenced separation into the opposed propagation directions of the data signals which in themselves run in opposite directions are achieved by using a bidirectional interleaved channel arrangement.

### BACKGROUND OF THE INVENTION

The present invention relates to a method and a device for the frequency band-dependent distribution and frequency band-dependent influencing of data signals of a WDM system having a multiplicity of channels which propagate in a bidirectional interleaved fashion and which have at least one frequency band between a first side and a second side.

When optical telecommunications transmissions are made in optic fibers, a number of channels can be transmitted in parallel at various wavelengths. This method of data transmission is referred to as WDM (wavelength division multiplexing). The bandwidth necessary for this is predefined essentially by the bandwidth of the available fiber amplifiers. At present, these are predominantly C band and L band erbium-doped fiber amplifiers (EDFA). In order to increase the data rate which can be transmitted on a fiber for a given channel data rate, the channel spacing is to be reduced. When the channel spacing is reduced, non-linearities in the optical fiber give rise to increasingly strong interactions between the channels, which limit the range of the data transmission.

WDM systems can be divided into unidirectional systems and bidirectional systems. In a unidirectional system, all the channels in one fiber propagate codirectionally, while in a bidirectional system channel groups in one fiber contra-propagate. Adjacent channels which respectively propagate contra-directionally with respect to one another constitute a special case in this respect. This method of operation is referred to here as “bidirectional interleaved”. With respect to non-linearities, the effective channel spacing here is twice as large as the physical channel spacing. This reduces the non-linear interference. The method of operation with bidirectional interleaved channel arrangement, therefore, presents advantages in this respect.

In this method of operation with bidirectional interleaved channel arrangement, it has been necessary up until now to use one amplifier per direction per band. In the case of erbium-doped fiber amplifiers (EDFA), 2 C band amplifiers and 2 L band amplifiers are therefore necessary. If operations are carried out with only one frequency band, one amplifier is necessary for each direction, therefore making a total of two amplifiers.

Because the number of amplifiers or generally the number of directionally acting influencing elements of the data signals constitutes a significant cost factor in the implementation of a data transmission link, an object of the present invention is to find a method and a device which enable the number of influencing elements to be reduced in comparison with the prior art.

### SUMMARY OF THE INVENTION

The inventors have recognized that it is possible to halve the number of necessary direction-oriented influencing elements, for example EDFA or DCF, through skillful use of the channel arrangement of a WDM system and corresponding systematic and direction-dependent distribution of the data signals between the individual channels; for example, via a bidirectional interleaved channel arrangement. In this context, the signals coming from the two sides are oriented in one propagation direction in an intermediate period, fed to at least one influencing element and the data signals are then forwarded again in the two different, original propagation directions in accordance with the arrangement of the channels.

Advantages of the present invention are the reduction in the number of influencing elements; for example, the amplifiers. As a result, a significant reduction in the space requirement is achieved, which has particularly advantageous effects on the repeater locations along a data transmission link. The same space requirement as for unidirectional or bidirectional C/L band operation is thus obtained with better performance features. In addition, the variety of types of amplifiers is reduced because the same amplifiers can be used as in unidirectional/bidirectional C/L band operation.

The basis for the central idea of the present invention is the use of all the inputs/outputs (ports) of an interleaver (4 ports, mainly only 3 ports are used), which permits channels running in opposite directions of a band to be directed in the same running direction through an optical amplifier. Such interleavers are generally known. The functional principle is described, for example, in “Ultra-low loss, temperature-intensive 16-channel 100-GHz dense wavelength division multiplexers based cascaded all-fiber unbalanced Mach-Zehnder structure”, Chihung Huang, et al., Conference on Optical Fiber Communication, OSA Technical Digest Series (Optical Society of America, Washington, D.C.), 1999, paper TuH2, pp. 79-81. The disclosed contents of this publication with regard to the method of operation of an interleaver is herewith fully incorporated into the present application.

Furthermore, the present invention provides the possibility of implementing a bidirectional interleaved channel arrangement without band filters. This is important for 40 Gb/s data rates because band filters may have transmission problems with these data rates which can have a persistent adverse effect on the 40 Gb/s signal.

In accordance with the inventive ideas described above, the inventors are proposing a method for frequency band-dependent distribution and frequency band-dependent influencing of data signals of a WDM system having a multiplicity of channels which propagate in a bidirectional interleaved fashion and which have at least one frequency band between a first side and a second side, which method directs all the data signals of the channels of a specific frequency band, coming from the first side and second side, in the same direction via a single branch (I or/and II) which is assigned to the frequency band and has at least one influencing part, all the data signals being subsequently forwarded between the first and second sides in accordance with their original propagation direction.

This method reduces the number of required influencing parts to half the influencing parts required in the prior art.

The influencing parts can be used, for example, to amplify the intensity of the data signals and/or compensate for the dispersion of a frequency band.

According to the present invention, the distribution of the data signals can be carried out using at least one interleaver with at least four inputs/outputs.

If the incoming data signals are transmitted on two frequency bands, the interleaver outputs adjacent channels of a frequency band at the same output, the data signals which are conducted to the influencing parts being distributed, as a function of the frequency band, between two branches and subsequently combined again at the passage through the influencing parts.

The distribution of the data signals between the branches (I, II) can be carried out using band filters or, if the two bands are run through in opposite directions to one another downstream of the interleaver, using circulators. In the case of circulators, the interleaver separates the bands into two directions upstream of the influencing parts and combines them again downstream of the influencing parts.

Furthermore, the combination subsequently can be carried out at the passage through the influencing parts using band filters, in which case it is irrelevant whether the channels in the bands run co-directionally or contra-directionally with respect to one another.

For the combination of the data signals subsequent to the passage through the influencing parts it is also possible to use couplers, but this results in a severe loss of power.

The C and L bands can serve as an example of a first and second frequency band. However, it is to be noted that the term frequency band is to be understood in the present invention to refer to all frequency intervals which do not overlap.

In accordance with the present invention, it is proposed, in addition to the method, to improve an optical data transmission link having a device for the frequency band-dependent distribution and frequency band-dependent influencing of data signals of a WDM system having a multiplicity of channels which propagate in a bidirectional interleaved fashion and have at least one frequency band between a first side and a second side, at least one branch having at least one influencing part being provided per frequency band, and carry out the improvement to the effect that at least one interleaver, preferably precisely one interleaver, is provided, and precisely one branch having at least one influencing part is provided per frequency band.

The at least one influencing part may be a, preferably multi-stage, amplifier which, if appropriate, contains an optical waveguide (EDFA) which is doped with rare earths, preferably with erbium. In addition, an influencing part can contain a dispersion-compensating part, preferably a dispersion-compensating fiber (DCF).

In accordance with the present invention, at least two frequency bands, preferably an L band and a C band, may be provided for the transmission of the data signals.

A particular embodiment of the optical data transmission link may include providing one interleaver per frequency band, a part for the frequency band-dependent distribution of the data signals, preferably at least one band filter, being provided upstream of the at least one interleaver, and the interleavers serving to align the channels upstream and downstream of the, in each case, one influencing part per frequency band.

On the other hand, the optical data transmission link may also provide for precisely one interleaver to be provided for two frequency bands, a part for the frequency band-dependent distribution of the data signals, preferably at least one circulator or band filter, being arranged downstream of the interleaver, and the interleaver also serving to align the channels.

Additional features and advantages of the present invention are described in, and will be apparent from, the Following Detailed Description of the Invention and the Figures.

### BRIEF DESCRIPTION OF THE FIGURES

FIG. 1 shows a schematic view of an interleaver.

FIG. 2a shows an outline of an in-line amplifier for C and L bands with bidirectional operation in opposite directions with band filters.

FIG. 2b shows a propagation direction of the channels in the C and L bands for the bidirectional method of operation in opposite directions according to FIG. 2a.

FIG. 3 shows bidirectional alternating operation, amplifiers operated in opposite directions with circulator.

FIG. 4a shows bidirectional operation in opposite directions, the signals running through the amplifiers in the same direction.

FIG. 4b shows a wavelength diagram relating to FIG. 4a.

FIG. 5 shows in-line amplifiers for a bidirectional interleaved channel arrangement with separate interleavers for the C and L bands.

FIG. 6 shows a terminal structure for a bidirectional interleaved channel arrangement, the signals running through the amplifiers in opposite directions.

FIG. 7 shows a terminal structure for a bidirectional interleaved channel arrangement with amplifiers which are operated in opposite directions, the band filters being replaced by circulators.

FIG. 8 shows a structure according to the present invention of a DCF (dispersion compensating fiber) module with dispersion compensation per band individually for the channels running to the left and to the right in this band (“bar”/“cross” or “even-numbered”/“odd-numbered”).

FIG. 9 shows a bidirectional interleaved operation for only one frequency band.

FIG. 10 shows table 1 with the channel arrangement for FIG. 2b and table 2 with the channel arrangement for FIG. 4b.

FIG. 11 shows the prior art of a repeater station for a bidirectional interleaved channel arrangement with, in each case, two amplifiers per band.

### DETAILED DESCRIPTION OF THE INVENTION

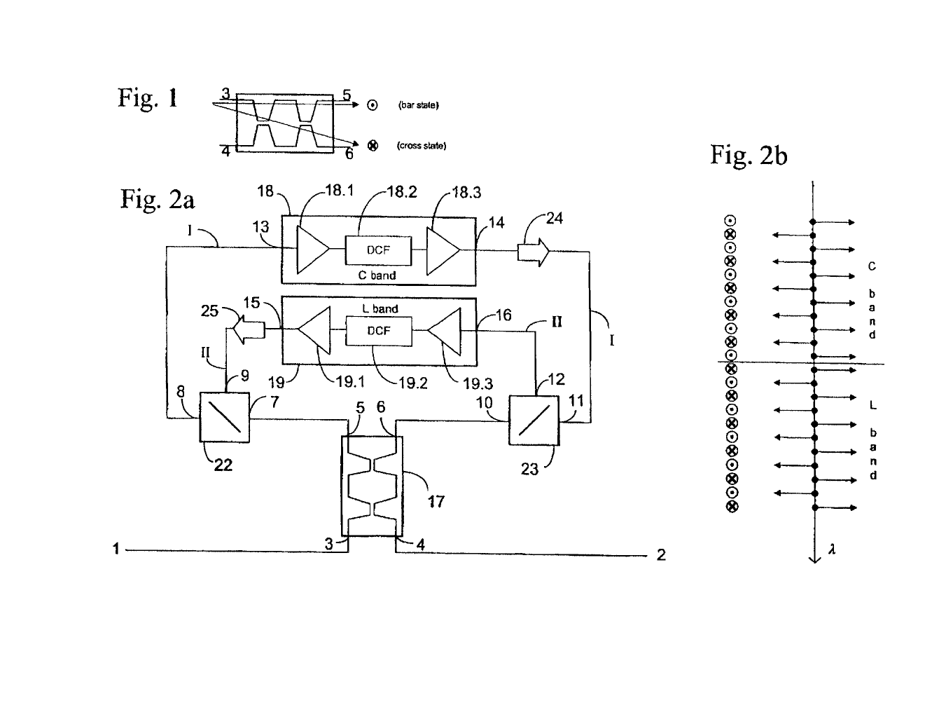

For a better understanding of the present invention, the basic method of operation of what is referred to as an interleaver will firstly be explained below. FIG. 1 shows such a 1:2 interleaver 17 in a schematic view, the interleaver being referred to in the following text simply as an interleaver. This is a component which can divide a channel comb which is equidistant in the wavelength space (numbered from 1 to n, or with alternations of “cross” and “bar”) into two subgroups of even-numbered channels and odd-numbered channels, and vice versa.

A channel at the input 3 emerges either as “bar” at the output 5 or as “cross” at the output 6 as a function of its wavelength. Correspondingly, a channel at the input 4 also emerges either as “bar” at the output 5 or as “cross” at the output 6 as a function of its wavelength. In abbreviated form, “bar” (circle with a dot in the center as the symbol) or “cross” channels or “states” (circle with a cross in the center as a symbol) are referred to. On an equidistant wavelength scale, the channels are “bar” channels and “cross” channels in an alternating arrangement. However, a precondition for this behavior illustrated above is compliance with the predefined convention for the arrangement of the channels. It is also to be noted that the interleaver not only operates from left to right in the direction shown here but also functions in the opposite direction.

In one use of this interleaver 17 in a data transmission link which has a bidirectional interleaved arrangement, the following cases can then be distinguished depending on the running direction:

Running direction from left to right:

Input of an even-numbered “bar state” channel at port 3 leads to port 5;

Input of an odd-numbered “cross state” channel at port 3 leads to port 6;

Input of an even-numbered “bar state” channel at port 4 leads to port 6;

Input of an odd-numbered “cross state” channel at port 4 leads to port 5.

Running direction from right to left:

Input of an even-numbered “bar state” channel at port 5 leads to port 3;

Input of an odd-numbered “cross state” channel at port 5 leads to port 4;

Input of an even-numbered “bar state” channel at port 6 leads to port 4;

Input of an odd-numbered “cross state” channel at port 6 leads to port 3.

On the basis of this distribution of the incoming and outgoing channels, it is therefore possible to generate a type of “rectification” of the channels which are then fed in a “rectified” state to an influencing element which acts only in a directional fashion, and after passing to the influencing element are split up again and thus fed into the data transmission link in the original propagation direction again.

An exemplary embodiment of this type of temporary “rectification” is shown in FIG. 2a, which shows the basic structure of an in-line amplifier system for a data transmission link with a bidirectional interleaved channel arrangement and two frequency bands.

FIG. 2a shows a schematic view of an optical data transmission link between a first side 1 and a second side 2 with an intermediately connected interleaver 17 with four inputs/outputs (ports) 3-6. The two ports 3 and 4 connect the sides 1 and 2 of the data transmission link, while the ports 5 and 6 lead to one band filter 22, 23 each. The incoming data signals of the C band are directed to the multi-stage amplifier 18 via the band filter 22, while the data signals of the L band are directed in the opposite direction to the multi-stage amplifier 19 via the band filter 23. Each multi-stage amplifier has two EDFA blocks 18.1, 18.3 and 19.1, 19.3 with dispersion-compensating fibers (DCF) 18.2 and 19.2 arranged between them. Light signals running in the return direction are suppressed via isolators 24, 25. After the data signals have passed through the amplifiers 18, 19 in opposite directions and separately, they are conducted to the ports 6 and 5 of the interleaver 17 again via the band filters 23 and 22. Here, the individual channels are distributed again in such a way that their original propagation direction is retained. The figures show the band filters only transmitting in the C band and reflecting in the L band by way of example. Other configurations in which the band filters operate, for example in a transmitting fashion at times and in a reflecting fashion at other times, are also possible.

The direction in which the channels run through the fiber is shown in FIG. 2b. The even-numbered and odd-numbered channels go through the interleaver alternating between the “cross” and “bar” state. The upper part of the channels belongs to the C band while the lower part of the channels is in the L band. Adjacent channels propagate in opposite directions both in the C and L bands. The distribution of the channels is illustrated in table 1 in FIG. 10.

It is to be noted here that only the two adjacent channels of the C and L bands are in the same direction. The objective of this arrangement of the channels is to conduct all the channels of the C band and all the channels of the L band in themselves through the amplifier of the respective band in the respective identical running direction. It is advantageous here if the amplifiers run in the same direction in themselves but in opposite directions relative to one another.

The “bar” channels which come into the C band from the left pass via port 3 to port 5 and the “cross” channels which come in from the right also pass to port 5 via port 4. This ensures that all the C band channels then run in the same direction. The following band filter (can also be replaced by a right hand-turning circulator) just lets the C band channels pass through (port 7 to port 8). Then, the C band channels pass through the associated amplifier and the downstream isolator. The C band channels just pass again through the band filter. Then, the “cross” channels pass from port 6 to port 3 via the interleaver, and the “bar” channels pass from port 6 to port 4. The amplified channels then continue their propagation in the original direction.

For the L band, all the channels exit the interleaver via port 6. They pass into the L band amplifier via port 12 of the bandpass filter. Then they pass via port 15 to port 9 and from there via port 7 to port 5.

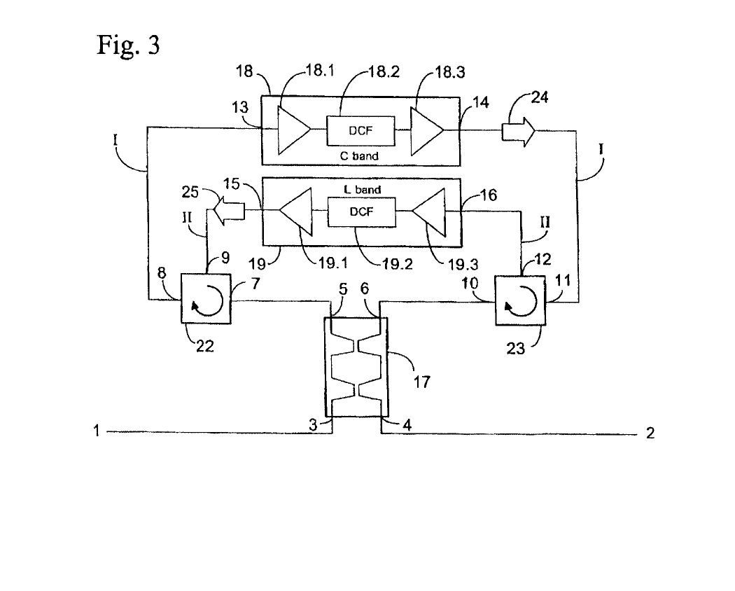

FIG. 3 shows a similar structure to FIG. 2a, but here the band filters, which may be problematical with data rates of 40 Gb/s, are replaced by circulators 22 and 23.

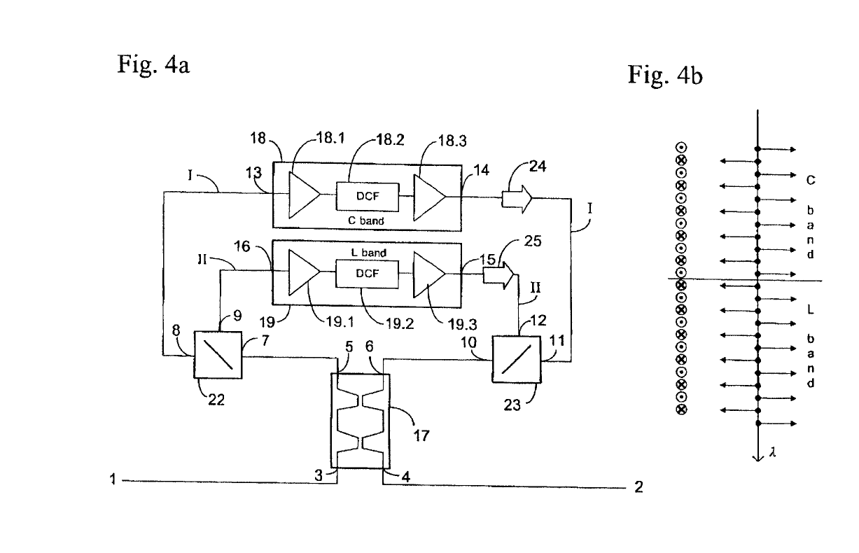

If the assignment of the direction is selected from table 2 in FIG. 10, the data signals pass through the amplifiers 18 and 19 in the same direction, as shown in FIG. 4a. This embodiment is, however, only possible with band filters, and not with circulators. The associated distribution of the directions of the channels is shown in FIG. 4b.

Both cases can be selected as desired. To do this, merely one channel or a number of channels are to be omitted, and the running direction is then to be suitably selected. In practice, this does not constitute a restriction because in any case channels are left free between the C and L bands in order to be able to operate with band filters.

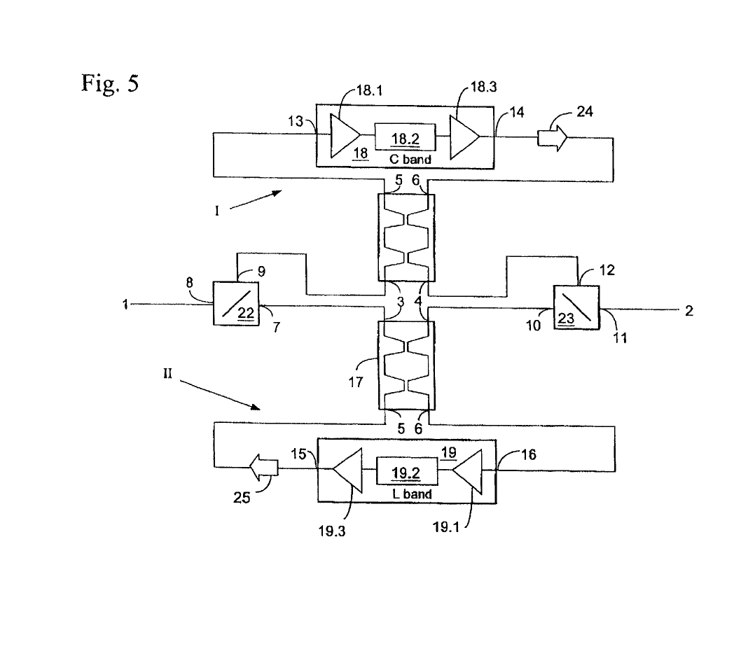

In the event of the bandwidth of the interleavers used covering in each case just one band, for example the C and L bands, a corresponding result of the channel alignment can be obtained by the use of one interleaver per band, as illustrated in FIG. 5. This figure shows how the operation for a bidirectional interleaved channel arrangement with an interleaver for the C band and an interleaver for the L band can be set up. First, all that is necessary is to switch the two band filters from FIG. 2a upstream of the interleavers 17, as a result of which each interleaver 17 can be fed the corresponding frequency band. The interleaver then ensures that the incoming data signals are rectified in each frequency band and conducted through the amplifiers 18 and 19. In this embodiment of the present invention, the number of amplifiers necessary is also halved in comparison with the prior art.

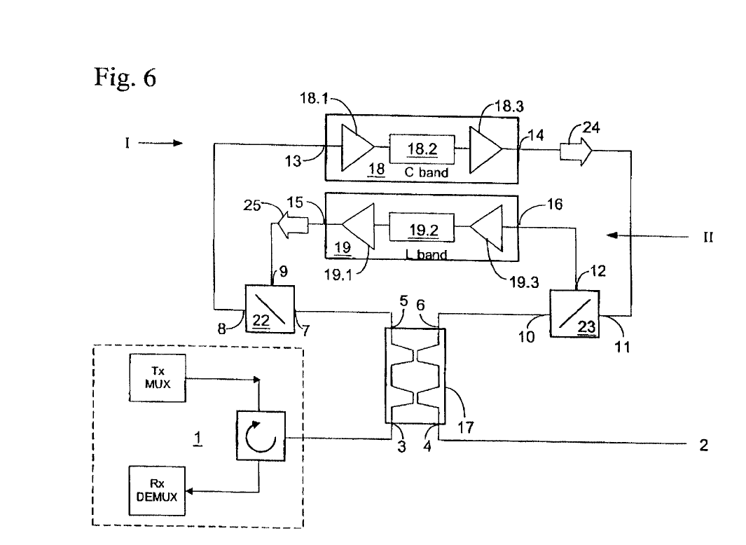

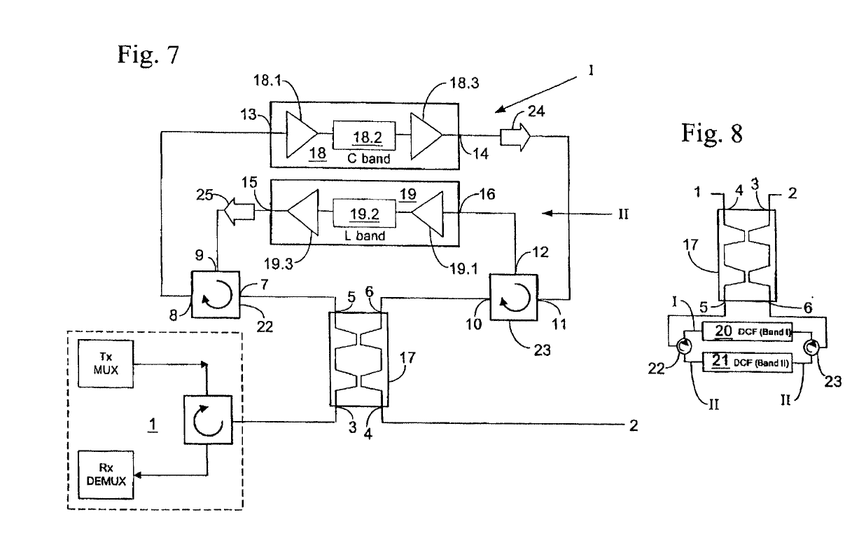

In FIGS. 2a, 3, 4 and 5, in each case repeaters (in-line amplifiers) are shown in a data transmission link. However, it is also possible to use the arrangement according to the present invention in a terminal configuration; that is, at the start of a data transmission link. Two examples with band filter and circulators are illustrated in FIGS. 6 and 7. The structure corresponds to FIGS. 2a and 3, but the first side 1 is illustrated in each case as a terminal with a multiplexer TxMUX, a demultiplexer RxDEMUX and a circulator.

According to the present invention, it is also possible to use any directionally oriented influencing element instead of the amplifiers 18 and 19. For example, FIG. 8 shows an exemplary embodiment with two dispersion-compensating fibers (DCF).

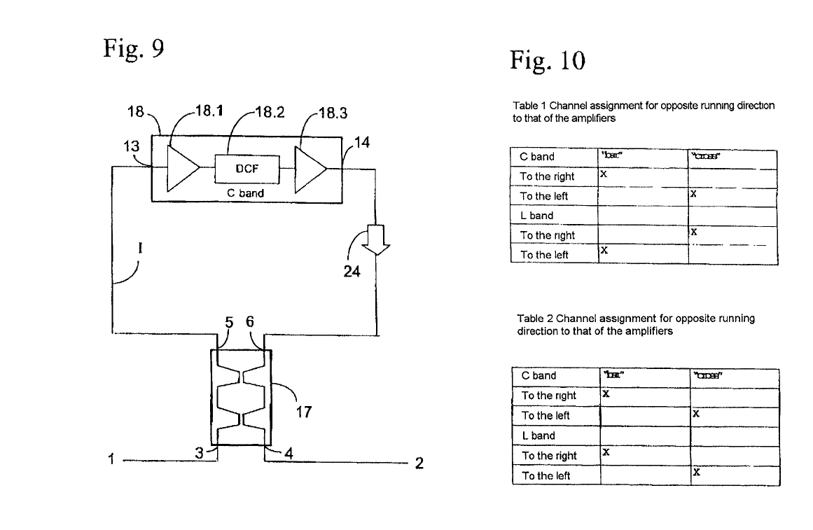

A particularly simple application of the abovementioned method is shown in FIG. 9, which shows the use of the interleaver 17 in order to make a saving of one amplifier in a bidirectional data transmission link with only one frequency band. Because only a single frequency band is used, and therefore only a single amplifier 18 becomes necessary, it is possible to dispense with the band filters or circulators.

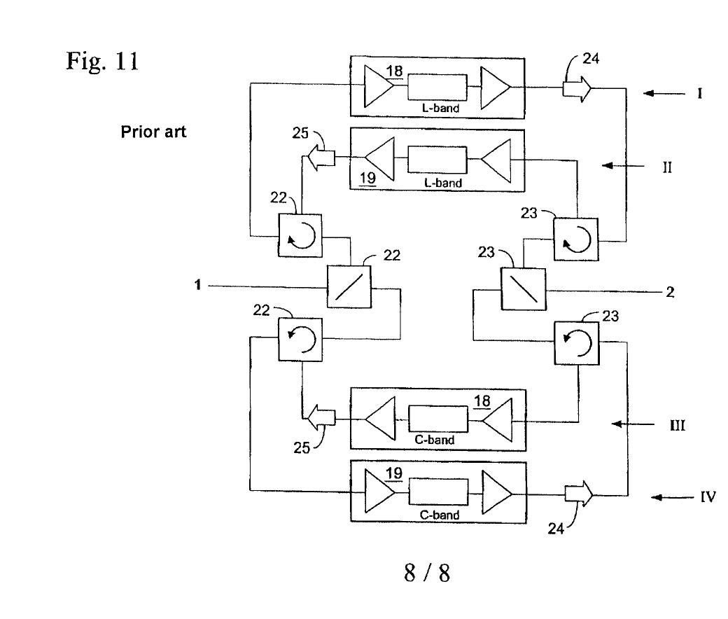

For the sake of better comprehension of the difference between the prior art, the conventional structure of a repeater in a bidirectional data transmission link is shown once more in FIG. 11. Without the use of the interleavers according to the present invention, it is necessary here to construct one amplifier per propagation direction and per frequency band, that is to say in total four branches I-IV, and use four amplifiers.

Overall, a method and a device for frequency band-dependent distribution and influencing of data signals of a WDM system are therefore presented making possible a temporary rectification and subsequent correctly sequenced separation into the opposed propagation directions of data signals which in themselves run in opposite directions, by utilizing a bidirectional interleaved channel arrangement.

Although the present invention has been described with reference to specific embodiments, those of skill in the art will recognize that changes may be made thereto without departing from the spirit and scope of the invention as set forth in the hereafter appended claims.

1. A method for the frequency band-dependent distribution and frequency band-dependent influencing of data signals of a WDM system, the method comprising the steps of:
providing the WDM system with a plurality of channels which propagate in a bidirectional interleaved fashion and which have at least one frequency band between a first side and a second side;
directing all the data signals of the channels of a specific frequency band, coming from the first side and the second side, in a same direction via a single branch which is assigned to the frequency band and which has at least one influencing part; and
forwarding all the data signals to the first side and the second side in accordance with their original propagation direction.

2. A method for the frequency band-dependent distribution and frequency band-dependent influencing of data signals of a WDM system as claimed in claim 1, the method further comprising the step of:
amplifying an intensity of the data signals of a frequency band via the at least one influencing part.

3. A method for the frequency band-dependent distribution and frequency band-dependent influencing of data signals of a WDM system as claimed in claim 1, the method further comprising the step of:
compensating for dispersion of a frequency band via the at least one influencing part.

4. A method for the frequency band-dependent distribution and frequency band-dependent influencing of data signals of a WDM system as claimed in claim 1, wherein the distribution of the data signals is carried out using at least one interleaver having at least four inputs/outputs.

5. A method for the frequency band-dependent distribution and frequency band-dependent influencing of data signals of a WDM system as claimed in claim 4, the method further comprising the steps of:
transmitting the incoming data signals on two frequency bands;
outputting, alternately, adjacent channels of a frequency band to different outputs via the interleaver;
distributing the data signals which are conducted to the influencing part, as a function of the frequency band, between two branches; and
combining the data signals at a passage through the influencing part.

6. A method for the frequency band-dependent distribution and frequency band-dependent influencing of data signals of a WDM system as claimed in claim 4, wherein the distribution of the data signals between the branches is carried out using band filters.

7. A method for the frequency band-dependent distribution and frequency band-dependent influencing of data signals of a WDM system as claimed in claim 4, wherein the distribution of the data signals which are conducted to the influencing part is carried out using circulators.

8. A method for the frequency band-dependent distribution and frequency band-dependent influencing of data signals of a WDM system as claimed in claim 4, wherein the step of combining is carried out subsequent to the passage through the influencing part using at least one of band filters and interleavers.

9. A method for the frequency band-dependent distribution and frequency band-dependent influencing of data signals of a WDM system as claimed in claim 4, wherein the step of combining is carried out subsequent to the passage through the influencing part using couplers.

10. A method for the frequency band-dependent distribution and frequency band-dependent influencing of data signals of a WDM system as claimed in claim 5, wherein C and L bands are used as first and second frequency bands.

11. An apparatus in an optical data transmission link for the frequency band-dependent distribution and frequency band-dependent influencing of data signals of a WDM system having a plurality of channels which propagate in a bidirectional interleaved fashion and have at least one frequency band between a first side and a second side, comprising at least one branch having at least one influencing part provided per frequency band, precisely one interleaver, and precisely one interleaver, is provided, and precisely one branch, having at least one influencing part, provided per frequency band.

12. An apparatus in an optical data transmission link for the frequency band-dependent distribution and frequency-band dependent influencing of data signals of a WDM system as claimed in claim 11, wherein the at least one influencing part is a multi-stage amplifier.

13. An apparatus in an optical data transmission link for the frequency band-dependent distribution and frequency band-dependent influencing of data signals of a WDM system as claimed in claim 12, wherein the amplifier contains at least one optical waveguide which is doped with erbium.

14. An apparatus in an optical data transmission link for the frequency band-dependent distribution and frequency band-dependent influencing of data signals of a WDM system as claimed in claim 11, wherein the at least one influencing part is a dispersion-compensating fiber.

15. An apparatus in an optical data transmission link for the frequency band-dependent distribution and frequency band-dependent influencing of data signals of a WDM system as claimed in claim 11, wherein at least two frequency bands are provided.

16. An apparatus in an optical data transmission link for the frequency band-dependent distribution and frequency band-dependent influencing of data signals of a WDM system as claimed in claim 11, further comprising:
an interleaver provided per frequency band; and
at least one band filter for frequency band-dependent distribution of the data signals, provided upstream of the at least one interleaver;
wherein the interleavers serve to align channels upstream and downstream of the at least one influencing part per frequency band.

17. An apparatus in an optical data transmission link for the frequency band-dependent distribution and frequency band-dependent influencing of data signals of a WDM system as claimed in claim 11, wherein precisely one interleaver is provided for two frequency bands, a part for the frequency band-dependent distribution of the data signals, which is one of at least one circulator and band filter, being provided downstream of the interleaver, and the interleaver serving to align the channels.
